(19) United States
(12) Patent Application Publication
(10) Pub. No.: US 2016/0132688 A1
(43) Pub. Date: May 12, 2016

(54) Task Oriented Passwords

(71) Applicant: PASSTASK, LLC, Princeton, MA (US)

(72) Inventors: Fred Curtis, JR., Princeton, MA (US); Terry Potter, Raymond, ME (US); Stan Miloszewski, Boxborough, MA (US)

(21) Appl. No.: 14/892,357

(22) PCT Filed: Jun. 17, 2014
(86) PCT No.: PCT/US14/42670

§ 371 Date: Nov. 19, 2015

Related U.S. Application Data
(60) Provisional application No. 61/836,277, filed on Jun. 18, 2013.
(60) Provisional application No. 61/924,370, filed on Jan. 7, 2014.

(51) Int. Cl. G06F 21/62

(52) U.S. Cl. CPC G06F 21/6218

(57) ABSTRACT

When the mobile device is awakened, a task oriented password system takes control of the device in order to present a screen in which the user must participate in a particular task prior to being granted access to the device contents or a particular application on the device. While not limited, in some embodiments, this particular task may be educational in nature. In this way, the user is exposed to educational content every time he attempts to access his device. Although each task is relatively short, the aggregate time during the course of a day may be substantial. The task oriented password system may include the mobile device, as well as one or more content providers, who generate the content that becomes part of the tasks described herein.

This application claims priority to U.S. Provisional Patent Application Serial No. 61/836,277, filed Jun. 18, 2013 and 61/924,370, filed Jan. 7, 2014, the disclosures of which are incorporate herein by reference in their entireties.

### BACKGROUND

Mobile devices are ubiquitous in today's society. The availability and use of smart phones and tablets have exploded in the past several years, with younger members of society at the forefront of this trend. Younger people use these devices for communicating with their friends via text, sharing information via social media sites, playing music and videos, playing games, and various other entertainment purposes.

At the same time, many parents worry that their children spend insufficient time on schooling and other academic or educational activities, often prioritizing the use of these mobile devices above these other pursuits. To counteract this, parental control applications exist, which make it possible to block certain device content, restrict access to certain device content to specific hours of the day, or restrict access to a predefined duration of time. These solutions may not be optimal.

Therefore, it may be beneficial to leverage young people's passion for their mobile devices to facilitate educational tasks or other activities.

### SUMMARY

When the mobile device is awakened, a task oriented password system takes control of the device in order to present a screen in which the user must participate in a particular task prior to being granted access to the device contents or a particular application on the device. While not limited, in some embodiments, this particular task may be educational in nature. In this way, the user is exposed to educational content every time he attempts to access his device. Although each task is relatively short, the aggregate time during the course of a day may be substantial. The task oriented password system may include the mobile device, as well as one or more content providers, who generate the content that becomes part of the tasks described herein.

In one embodiment, a mobile device is disclosed. This mobile device comprises a processing unit, a storage element in communication with the processing unit, a touchscreen, wherein the storage element comprises instructions, which when executed by the processing unit: present a user with a first screen on the touchscreen; present the user with a task oriented password screen on the touchscreen, following completion of an action with respect to the first screen, wherein the task oriented password screen requires the user to complete a task in accordance with the content displayed on the touchscreen prior to being granted access to one or more applications loaded on the device.

According to another embodiment, a task oriented password system for burst learning is disclosed. This task oriented password system comprises one or more task content providers, a mobile device and a device specific software component disposed in a storage element of the mobile device, wherein the device specific software component presents task oriented passwords to a user, wherein the task oriented passwords comprise task contents received from the task content provider. In a further embodiment, the task oriented password system is designed to support multiple tenants.

### BRIEF DESCRIPTION OF THE FIGURES

For a better understanding of the present disclosure, reference is made to the accompanying drawings, which are incorporated herein by reference and in which:

FIG. 1 shows a representative mobile device having a screen that uses a “slide to unlock” mechanism;

FIG. 2 is a flowchart according to one embodiment;

FIG. 3 is a flowchart according to a second embodiment;

FIG. 4 is a flowchart according to a third embodiment;

FIG. 5 shows a representative architecture according to one embodiment;

FIG. 6a shows an example of a particular portion of the database, referred to as the Knowledge Bank, from a task content administrator's view;

FIG. 6b shows the organization of the Knowledge Bank according to one embodiment;

FIG. 7 shows an example of multiple Knowledge Banks;

FIG. 8 is a flowchart showing how task content is generated according to one embodiment;

FIG. 9 is a flowchart showing how task content is generated according to another embodiment;

FIG. 10 is a flowchart showing how task content is generated according to another embodiment;

FIG. 11 is a representation of the database according to one embodiment;

FIG. 12 is a representation of the collection of attributes according to one embodiment;

FIG. 13 represents one method for selecting the next task content to be delivered; and

FIG. 14 represents one embodiment of the task selection algorithm which provides the individual tasks to be completed for each Task Oriented Password for each user using each Knowledge Base.

### DETAILED DESCRIPTION

As stated above, mobile devices are pervasive, with almost all younger people owning one or more such devices, such as but not limited to smart phones, tablets, or portable computers. “Mobile device” is a generic term used to refer to a variety of devices that allow people to access data and information from wherever they are. This disclosure may refer to phones, tablets and portable computers, although other devices are also within the scope of the disclosure. These phones, tablets and portable computers may utilize one of a plurality of different operating or control systems, such as those offered by APPLE, MICROSOFT, GOOGLE, and others. These devices include a processing unit in communication with a storage element which is used to store instructions, which when executed by the processing unit, are able to perform the actions described herein. The device may also include various input/output (I/O) ports, and optionally a keyboard or other method of input, control and output. One feature on many devices today is the existence of a touchscreen display. While offering incredible versatility, one disadvantage of a touchscreen is the ability to inadvertently perform an unintended function. For example, the touchscreen may be accidentally touched while in the user's pocket, and may inadvertently make a phone call or perform some other function.

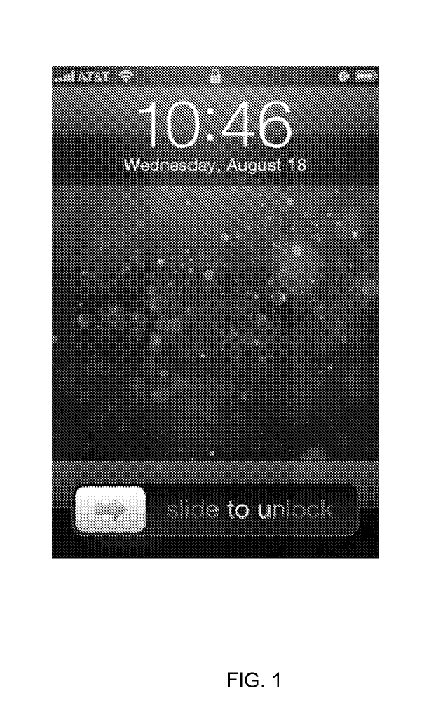

Consequently, most devices having touchscreen displays present a first screen to the user, as shown in FIG. 1. This first screen in this example requires the user to create a specific tactile, motion, other pattern or method in order to unlock the device for use. Most mobile devices required the device to be unlocked to access its device contents. In some embodiments, that tactile pattern may include moving the user's finger from a first position to a second position along a straight line, otherwise known as “slide to unlock”. Other tactile patterns are typically required by other devices as well. For example, some devices require the user to move his finger along the touchscreen over some minimum distance. In other embodiments, an indication unique to the owner, such as a biometrics sensor indicator, may also be used. In yet other embodiments, the device may receive a wireless signal from another device possessed by the user, such as a keyFOB or another wireless device. For example, a Bluetooth communication may be sent to this device by another device in order to unlock it. Throughout this disclosure, reference is made to this “tactile pattern”; however, it is understood that this term also includes the steps necessary for a user to access a device using biometric sensors and associated analytics or any other technique.

Once the user executes this tactile pattern, the mobile device then displays the home screen. This home screen typically has a variety of icons, each representing some device content such as an application that the user may launch. In some embodiments, the mobile device may have a plurality of home screens, each having one or more icons on it.

Typically, an application may be started by pressing, or tapping, on the touchscreen in the region corresponding to the icon, or by other means. In some embodiments, the application may be started by pressing twice on that region in rapid succession. Once the user performs this tapping motion, the application opens, allowing the user access to it. These applications may be a variety of different undertakings, such as social media, such as TWITTER, FACEBOOK, FOURSQUARE, etc.; web browsers, such as SAFARI; video applications, such as YOUTUBE; video chat applications, such as FACETIME, and gaming applications. In addition, an application that allows the user to place a telephone call, email or text another user may also be included on one or more of these home screens.

In some embodiments, the home screen has a first portion, typically along the bottom of the screen that includes commonly used applications, such as phone, messaging and contacts. This first portion may be located on each of the plurality of home screens, so that the user can access any of these commonly used application, regardless of which home screen is being displayed by the mobile device. The home screen also has a second portion, which includes a plurality of icons, each representing a particular application or set of applications. This second portion is unique to a particular home screen. In other words, a first home screen may have a first set of applications in the second portion and a set of commonly used applications in the first portion. A second home screen may include a second set of applications, different from the first set of applications in its second portion, and the same set of commonly used applications in its first portion.

In other embodiments, after the tactile pattern is entered, a password screen may be presented to the user. This password may be a numeric password, such as a unique set of digits. In other embodiments, this password screen may be a unique tactile pattern, such as a user-defined sequence of connecting a plurality of dots displayed on the touchscreen.

The present disclosure describes a software system which has a device specific software component working in conjunction with the rest of the system, which when installed into the storage element of the mobile device and executed by the processing unit of the mobile device, performs the actions described herein. This device specific software component may be written in any suitable programming language and may be downloaded to the mobile device using any means, such as USB, Ethernet, or WIFI. The device specific software component can then be installed and configured, as described in greater detail below. The device specific software component can have numerous variations and configuration options, as described herein. In all embodiments, the device specific software component is used to display the task oriented password screens and its associated tasks and receives any inputs given by the user to those tasks. The task oriented password screen is a unique aspect of the present disclosure and includes a screen in which the user must participate in a particular task prior to being granted access to the device contents or a particular application on the device.

The task oriented password system takes control of the device in order to present the screen in which the user must participate in a particular task prior to being granted access to the device contents or a particular application on the device. Note that while the task oriented password screen takes control of the device, it must allow for emergency access to selected applications such as telephone and ability to halt or reset the device in case it becomes frozen. Examples of these tasks that the user must participate in are explained in more detail below.

The task oriented password system may take control by creating special device functions that launch task oriented passwords upon awaking, and/or being powered on, based on administrator setting and/or schedules. Alternatively, the task oriented password system may take control using existing or other available device functions, such as parental control features or other related methods.

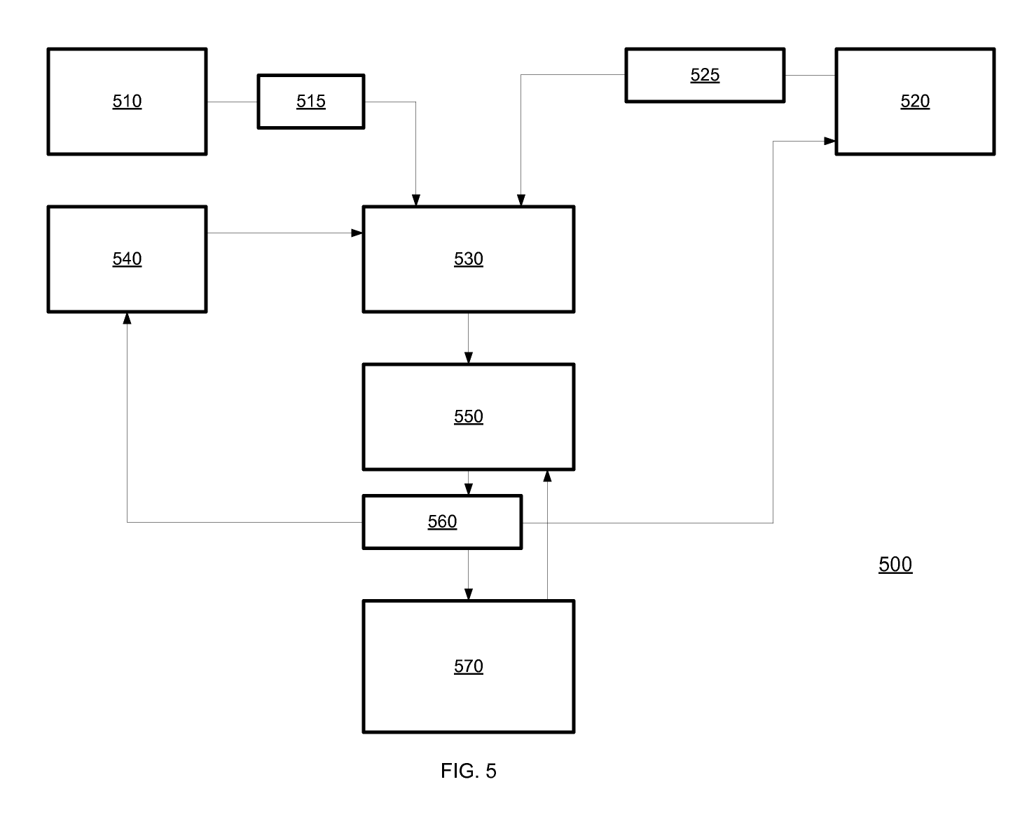

FIG. 5 shows a representative architecture that can be employed to implement the system of the present disclosure. System 500 is made up various components. The system 500 includes a database 530, which may contain task content that is intended to be presented to the user. As described in more detail below, the task content may be visual, audio, interactive, or other data types. The task content within the master central or distributed database 530 may be created in a number of ways. In some embodiments, the task content may be Personalized task Content 510, created by, for example, the parent or task content administrator. The term “Personalized Task Content” signifies that the task content is made specifically for the particular user or group of users, rather than being generic task content generated for a plurality of users. This term refers to the close relationship between the task content and the user. In some embodiments, the task content administrator may create Encouragement Pictures that may be randomly incorporated in the task content delivered to the user. The Encouragement Picture may be a picture of the family, the user's favorite pet or sports figure, or any other image designed to encourage the user. The task content administrator may also create Encouragement Statements, which are described in more detail below. The created task content may be photographs, slides, videos or other types of content.

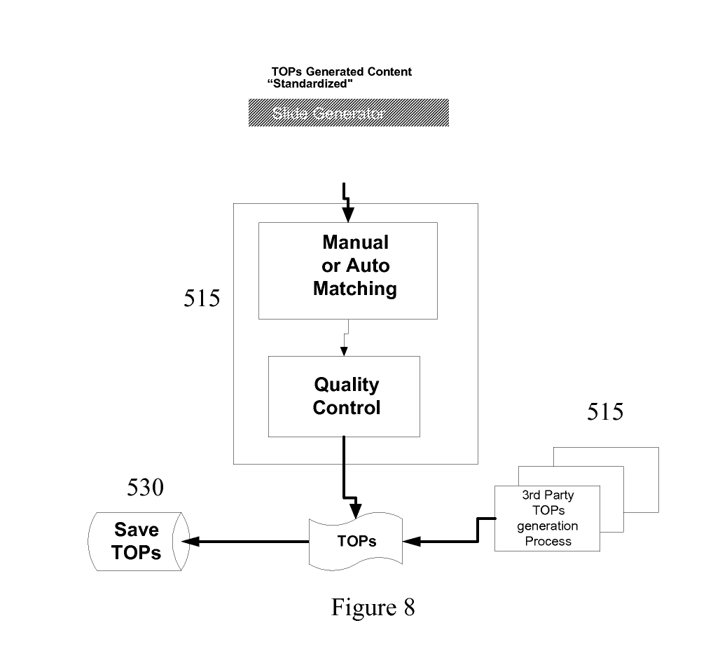

In one embodiment, an application may be provided within the context of the system 500 to allow the task content administrator to create task content in the required format. FIG. 8 shows one such embodiment. In this embodiment, an application 515, which may facilitate manual or automatic matching of content for tasks, and may also provide a quality control component, is used. Content is input to the application 515, which parses the information to create task content in the format required by the mobile device (represented as “TOPS” in FIG. 8. This formatted task content is then stored in the database 530.

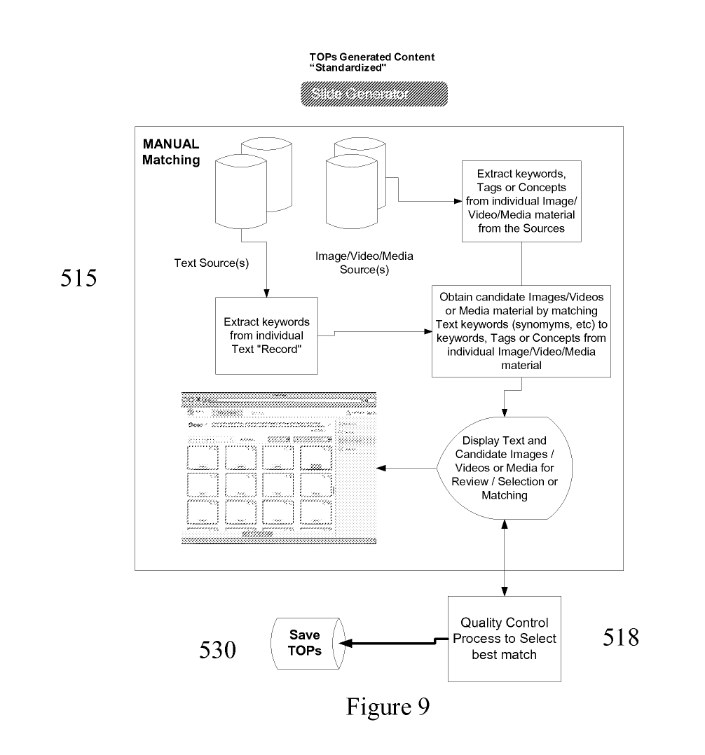

In a particular embodiment, shown in FIG. 9, the personalized task content subsystem 510 may include an application 515 which may be able to accept content for tasks in a variety of formats, such as .mp4, .pptx, .docx, .pdf and others, and create task content in the format required by the system 500. In this embodiment, text information may be extracted from text sources and image/video/media may be extracted from other sources and matched with the text information. This matching can be done manually as represented in FIG. 9.

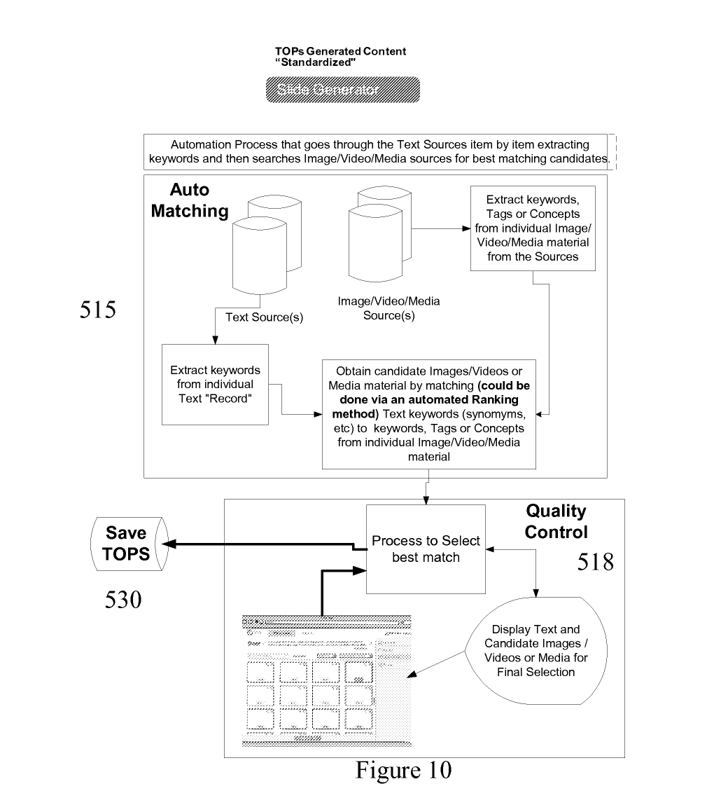

In another embodiment, this matching may be performed automatically as shown in FIG. 10. In either embodiment, a quality control process 518, which could be automated, may be used to review the matching prior to saving the resulting task oriented password. The application 515 may be part of the system 500, which facilitates the ability of the task content administrator to easily incorporate these Encouragement Pictures and/or other content.

Returning to FIG. 5, in some embodiments, the task content may be Non-personalized Content 520, and may be generated by third party task content providers. This non-personalized task content 520 may be generated in a format that is readily accepted by the system 500. However, in other embodiments, the content may need to be reformatted, such as by Plug-In 525, which converts the non-personalized content 520 to a task format acceptable to the system 500. Plug-In 525 may use the same components as that used by Application 515. The reformatting of content, as described in application 515 and Plug-In 525, is within ordinary skill in the art and only requires an understanding of the required task output format and the various acceptable input formats. These third party task content providers may be application developers, schools, or other commercial entities. In yet other embodiments, the system 500 may allow the creation of a social network. For example, various users may be friends, neighbors or classmates and may create a social network within the application. In some embodiments, members of this social network are able to create task content for consumption by other members of the social network. For example, a user may upload a photo, which is tagged or otherwise identified as being available to members of his social network. For purposes of clarity, these images are referred to as Peer Pictures, although they are not limited to pictures or any other content type. These Peer Pictures may be another form of Non-personalized Content 520.

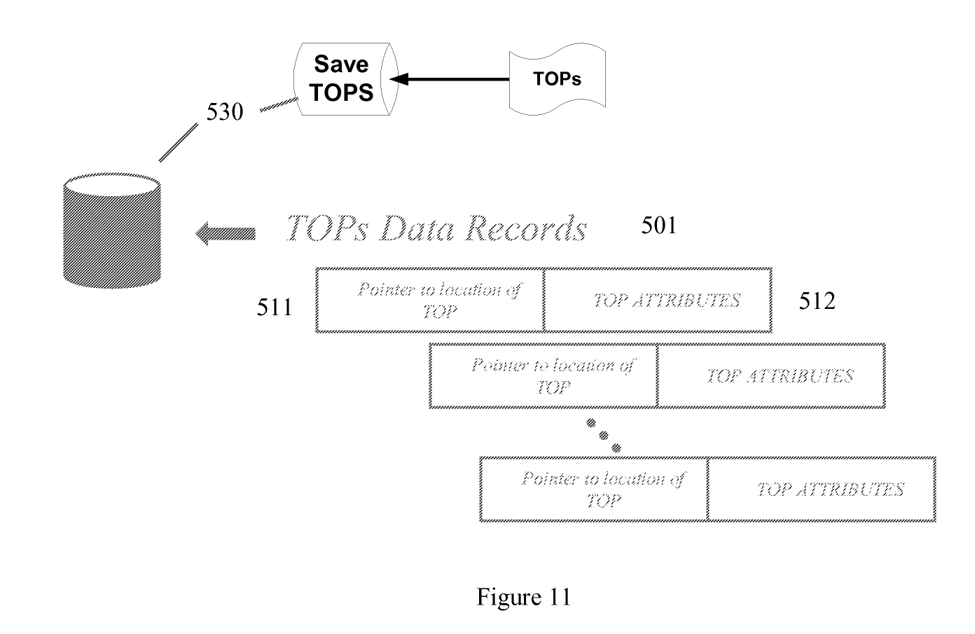

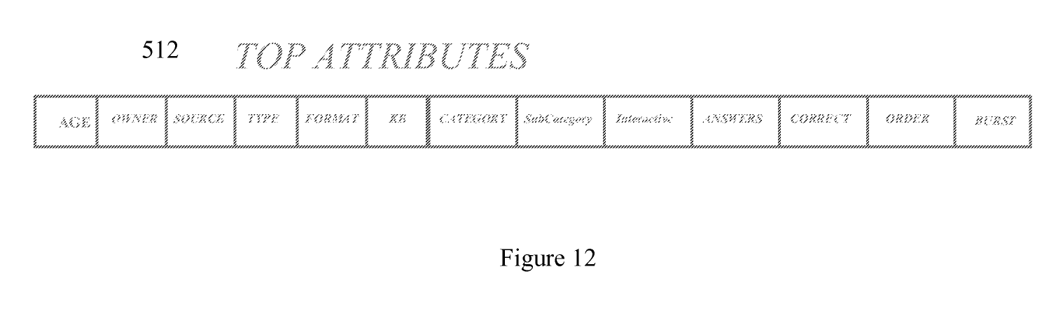

Task content, which as described above, may be generated for and personalized for a particular user, or for a plurality of users, may be stored in a database 530. This database 530 may be a depository for all task content that is accessible to the user. In other embodiments, the database 530 may only contain task content that is appropriate for the user (as will be described in more detail below). FIG. 11 is one representation of the database 530. It contains an individual task oriented password data record 501 for each task oriented password task. This data record 501 contains two parts: 511 represents the pointer to the actual location of the combined image/text/video/media task oriented password task that would get displayed on the user device and 512 contains the collection of needed attributes that are associated with each task oriented password task. FIG. 12 is one representation of the collection of attributes 512 associated with task oriented password task. Attributes include:

Age: a representation of the appropriate age group for this task oriented password task;

Owner: this is the owner of the knowledge item or task that will be delivered to the user;

Source: this is the location of the source material for which the knowledge items or task is assembled;

Type: this is the type of knowledge (text, image, media material that makes up the knowledge item or task;

Format: this is the format for which the knowledge items or task is stored for retrieval;

Knowledge Bank: This is the collection of knowledge items or tasks that are organized by category and subcategory and are delivered to the user;

Category: This is a representation of the category (i.e. math, geography, etc.) that this task oriented password task belongs to;

Subcategory: This is a representation of the subcategory (i.e. geometry, trigonometry; algebra; etc.) that this task oriented password task belongs to;

Interactive: This is an indication of whether the task oriented password task is interactive and requires input from the user;

Answers: This represents a list of possible answers to the task oriented password task;

Correct: This represents the correct answer;

Order: This indicates whether this task oriented password task is part of a sequential set of tasks, and if so, its position in that sequence; and

Burst: This is the length of time that the task is available to the user to view, respond and/or complete;

Of course, other or additional attributes may also be assigned to each task.

Returning to FIG. 5, the database 530 may cooperate with the parent or task content administrator 540, and is used to configure the task content that will be served to the user. The configuration may include various settings. For example, the parent or other task content administrator may be able to set the user's age, grade level, skill level, sex and interests. The task content administrator may also choose the type of task content such as subject matter and/or topic categories and subcategories, which may include in any combination video, audio, interactive, textual, etc, and the percentage of each type of task content that is served to the user.

The Task Oriented Passwords (TOPs) tasks are stored or associated with their respective topic categories and subcategories in one or more Knowledge Banks. For example, the database 530 may contain task content from a plurality of different third party task content providers. Non-personalized task content 520 from a plurality of third party task content providers may be stored in several Knowledge Banks, where a Knowledge Bank is a portion of the content contained in the database that is associated with a particular third party task content provider. Additionally, the Knowledge bank may include additional information, such as information inferred about the user based on responses to previous task content. In another embodiment, each Knowledge Bank may be associated with a particular subject or category. For example, a Knowledge Bank is also sometimes referred to as Knowledge Base may include knowledge and task content associated with math or a foreign language or another category.

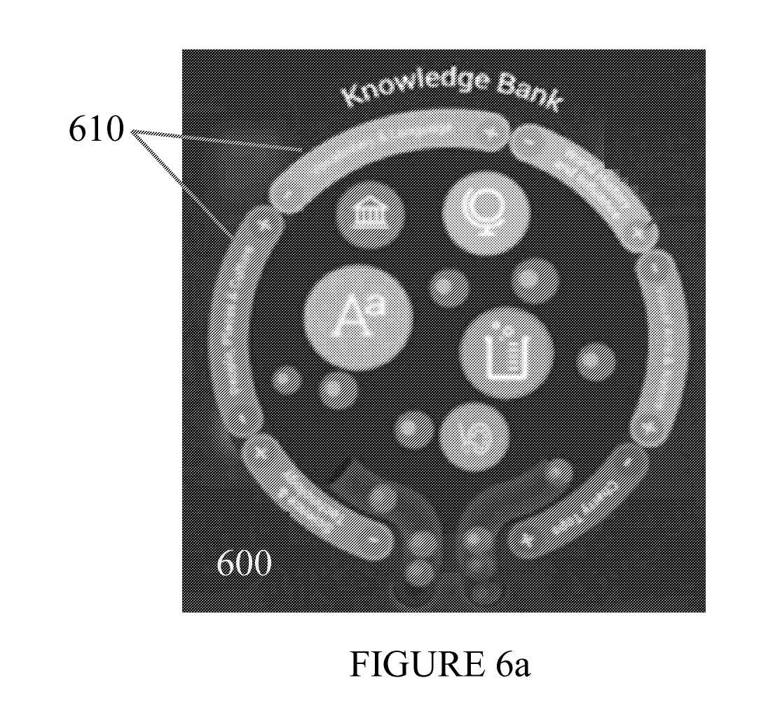

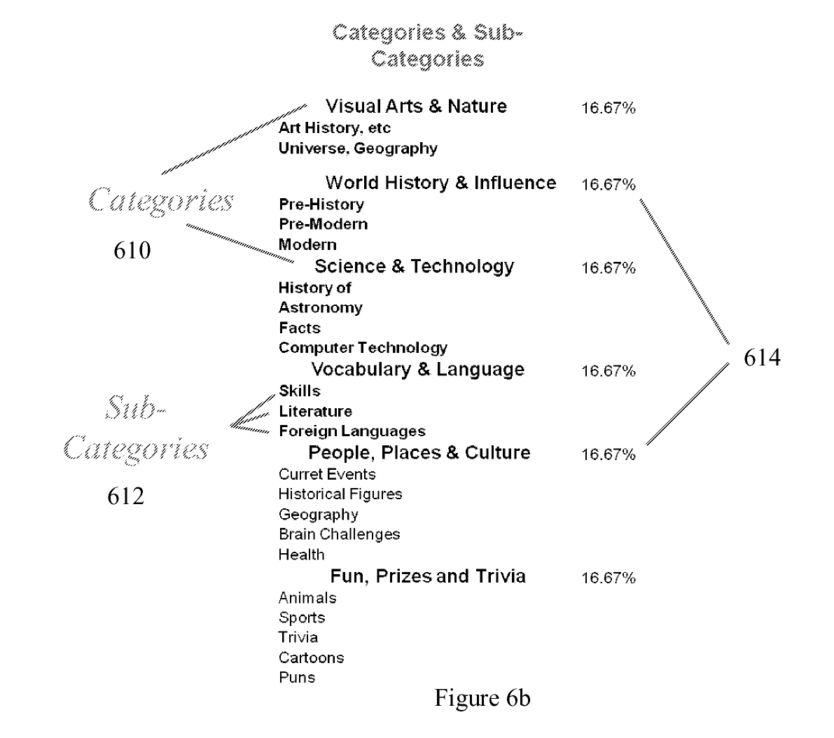

FIG. 6a shows an example of a Knowledge Bank 600 from a task content administrators' view. The task content administrator may be able to select the composition of topics stored in the database 530. In FIG. 6a, “+” and “−” operators are used to vary the percentage of task content which is associated with a particular category. These can be manipulated by the task content administrator with the support of an adjustment algorithm to ensure that the percentages add up to 100% across all categories. These Knowledge Bank(s) may also be represented as shown in FIG. 6b, allowing the task content administrator to organize the topic categories 610 and subcategories 612 as well as percentages 614 of each type of task content to be served to the user.

There may be cases where a user has more than one Knowledge Base assigned to them by a task content administrator 540. Normally, however only one Knowledge Base is active at any one time and thus the task selection algorithm function 550 will deal with that particular active Knowledge Base while the other Knowledge Bases assigned to the user are marked “inactive”. If there are more than one Knowledge Base active at a time for a user, the algorithm function 550 may be able to dynamically switch between them based upon administrator settings which could include either a schedule, frequency or other method some combination of settings. The algorithm function 550 will maintain the desired frequency of each Knowledge Base independently.

Returning to FIG. 5, an algorithm function 550 may then be used to select the task content to be delivered to the user. For example, the task selection algorithm function 550 may have information about the user's responses, so as to determine whether the user is correctly answering a question, or incorrectly answering a question. This information may be used in conjunction when the database 530 to select the next task content to deliver to the user. For example, if the user has incorrectly answered several questions in a row, the algorithm function 550 may select task content that is easier in nature, or task content which does not require a response from the user. This may be done to insure that the user does not become discouraged. In some embodiments, a number of incorrect answers may spur the delivery of an Encouragement Picture or Peer Picture, as described above. In some embodiments, the task content for which the incorrect answer was generated is stored and is repeated at a later time to better reinforce the task content. In some cases, the selection of the next task content may be dependent on what was previously sent, regardless of the user's response.

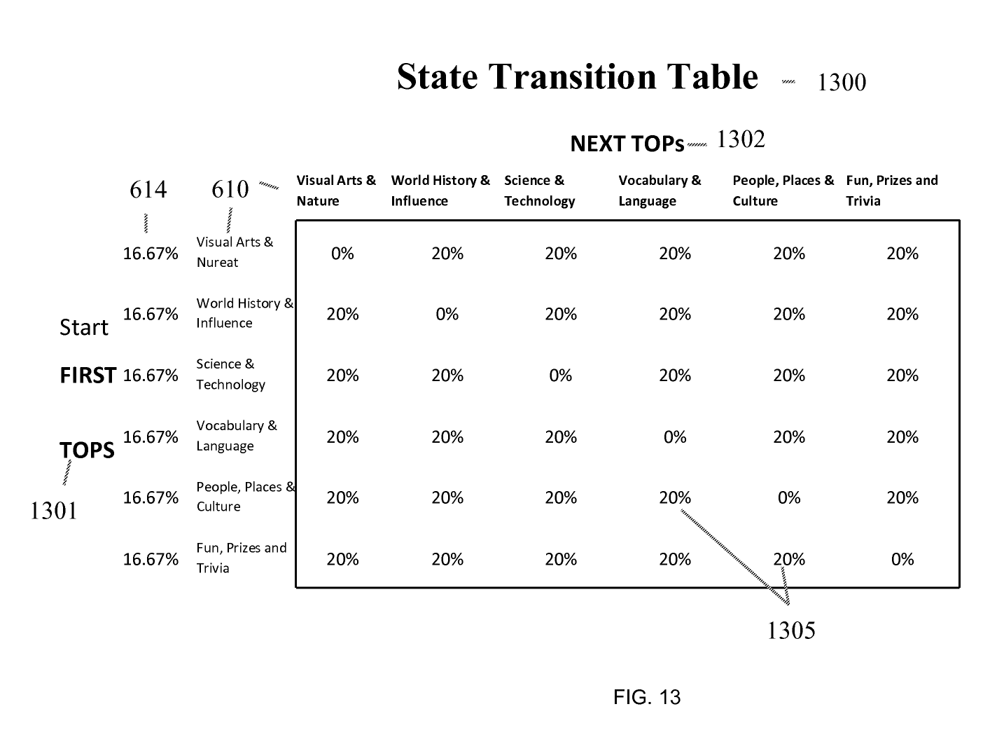

FIG. 13 represents one method in which the selection of the next task content to deliver is designed in the algorithm function 550 to meet the task content categories 610 and subcategories percentage 614 goals set by the task content administrator 540. The algorithm function 550 and implementation is also designed to allow the task content administrator 540 to dynamically adjust the percentage goals as well as add, edit or delete topic categories and/or subcategories. Note also that the task selection algorithm function 550 can itself dynamically adjust percentages based upon user's performance.

In the embodiment of FIG. 13, one method where selection of the next task oriented password task depends on what was previously sent is represented. FIG. 13 represents a State Transition Table or Matrix 1300 and can be viewed as a Markov Model. Note that this facilitates both manual and automatic adjustments to the task selection process. On the left side of the table, topic Categories 610 and frequency of occurrence of these categories 614 arranged via the Knowledge Base. Across the top of the table, the topic categories 610 are listed. In the table entries, frequencies 1305 that represent the frequency of the next task oriented password task category to be delivered are shown. The table may be used in the following manner:

For the first task oriented password task category, a random number between 0 and 100 is selected and using the frequency 614, the category 610 for the task oriented password task is selected. Once that task is completed, a new random number is selected and using the row of frequencies 1305 associated with the previous task oriented password task category 1301, the next category 1302 (across the top) to pick the task oriented password task from is determined. This process can continue, and may be augmented based upon other setup parameters or automatically based upon users' performance.

A similar method can be used to select the topic subcategories 612 thus leading to a multi-layered state transition table or matrix for each user.

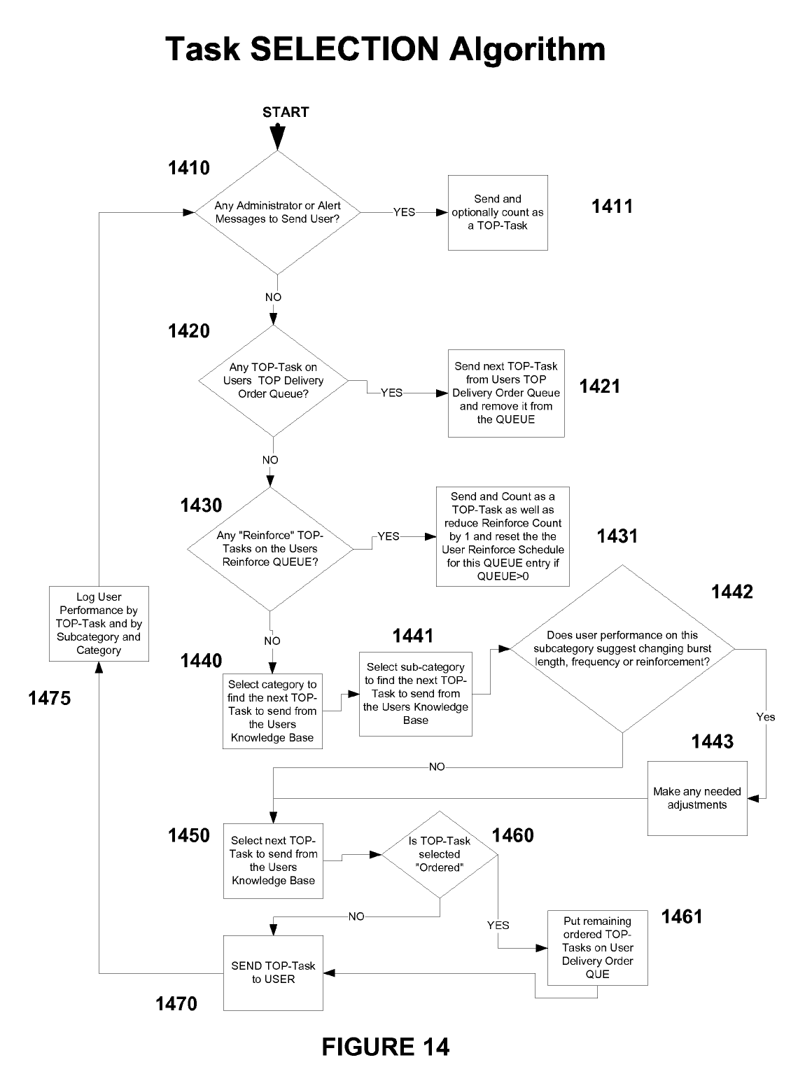

FIG. 14 shows another embodiment for selecting the next task to present to the user. In this embodiment, the algorithm is designed to allow any administrator alert message to have first priority in being delivered to the user (as shown in step 1410). If there is a message, then it is delivered, optionally as a task oriented password-Task as shown in step 1411. In other words, in some embodiments, the delivery of a message may constitute a task that needs to be completed. In other embodiments, this message is not considered a task and the rest of the task selection algorithm is executed.

If there are no messages, then the task selection algorithm determines if there are any TOPs-task oriented password tasks on the TOPs-Delivery Order Queue (as shown in step 1420). The TOPs-Delivery Order Queue is where the Tasks are placed if there are multiple Tasks to be delivered in a sequential order. For example, some knowledge that had been broken into multiple smaller burst tasks by a task content administrator. This knowledge must be delivered in a predetermined order. If there are any tasks in the queue, it is delivered and removed from the TOPs-Delivery Order Queue (as shown in step 1421).

If there are no items on the TOPs-Delivery Order Queue, the task selection algorithm moves the the next inquiry. If there are any “Reinforce” Tasks on the user reinforce queue, (as shown in step 1430), that Task is delivered to the user and then the reinforce count is reduced by one (as shown in step 1431). The reinforce clock for this reinforce TASK is reset if the reinforce queue for this Task has any more entries remaining. Items are also placed on the reinforce queue after the timer has expired. A reinforce queue may exist for each user. The schedule clock for each reinforce Task could be randomly set at a predetermined time intervals so as to expire and make the Task available for delivery by putting it on the user reinforce queue. In another embodiment, the queues could be done by interrupts that occur before sending a non-queued Task.

If there are no items on the reinforce queue, then the user Knowledge Bank category is selected (as shown in step 1440) followed by the subcategory (as shown in step 1441). The algorithm then reviews the users' performance on past tasks in this category and subcategory and decides if it needs to make adjustments to this user's Knowledge Bank subcategory burst length, frequency or reinforcement settings in order to help improve the users' performance (as shown in step 1442). If changes are needed, these changes are made (as shown in step 1443) and then the actual Task to be delivered is selected from the user Knowledge Bank (as shown in step 1450).

If the Task that was selected was the first of an ordered group of Tasks (as shown in step 1460), then the remaining Tasks in the ordered group are put on the user TOPs delivery order queue (as shown in step 1461) and the selected Task is sent.

After the Task is sent to the user, this task selection algorithm logs the user's performance by Task, subcategory and category and then loops back to step 1400 to repeat this procedure.

Other variations of this selection algorithm are also possible For example, content may be varied if the user has successfully answered a specific number of questions correctly. For example, an Encouragement Picture or Peer Picture may be displayed as a reward. Rewards are not limited to Encouragement or Peer Pictures. In some embodiments, the difficulty of the content task may be automatically increased based on the number or percentage of correct answers.

Other variations on the task selection algorithm may also be included in the Algorithm Function 550. These variations in the algorithm may use information about user behavior (i.e. correct answers, incorrect answers or sensor input) in conjunction with the task content resident in the database 530 to select task content to be next delivered to the user.

A task content delivery tracking function 560 may also track the task content that has been delivered to the user. This information can be used in many ways. For example, in some embodiments, usage information (such as amount of task content delivered, amount of task content delivered as a function of time, number of correct answers, type of task content delivered, etc) may be returned to the parent or task content administrator. Additionally, some third party generated task content 520 may be used on a royalty basis, such that each display of task content material triggers a fee from the task content provider. The task content delivery tracking function 560, or reporting system, may report the task content used by each task content provider among other items, and may optional supply a list of the task content used and by whom. In some embodiments, this task content delivery tracking function 560 may be incorporated in the task selection algorithm function 550. Note also that information on the source of task content, count and/or frequency may be used in dynamically selecting the next task content to display. For example, one set of content tasks may be viewed as more appropriate for a particular age group or may be viewed to have a limit on usage or cost. In other embodiments, this task content delivery tracking function 560 may be incorporated in the user's device 570. In some embodiments, the task content delivery function or reporting system may track and report performance and usage by users and administrators.

Organizationally, database 530 may reside in a variety of locations. For example, it may be resident in the cloud, such that all accesses to the database 530 require internet or other connectivity. However, there are low storage requirements for the user's device in this embodiment. In this embodiment, the task selection algorithm function 550, task content delivery tracking function 560 and database 530 may be disposed in the cloud as well, may be resident on the user's device 570, or may reside on one or more other devices and/or computers.

In another embodiment, the database 530 may be resident on the user's device 570. In this embodiment, the task selection algorithm function 550 and the task content delivery tracking function 560 may also reside on the user's device 570. This embodiment may require the greatest amount of storage on the user's device 570, but allows task content to be accessed even when internet/communications connectivity is not available.

In a third embodiment, the database 530 may be resident in the cloud, with a portion of the database 530 downloaded to the user's device 570. This may be used to reduce the storage requirements of the application on the user's device, while not requiring internet/communications connectivity when each type of task content is to be delivered.

There are environments where a users device has limited access to bandwidth which can limit the amount of task content available to the task oriented password system. With communication to a central database or other devices, the task oriented password system can have more complex multimedia tasks available. As a result, the task oriented password system needs an approach to handle limited bandwidth situations. In one embodiment, a dynamic cache algorithm adjusts what is needed on the user's device based on the devices current storage capacity, the task content selection and delivery requirements as well as frequency of connection to a central or distributed database. In other words, the task oriented password system may be designed to support a dynamic cache algorithm acting as a feedback control system to move relevant task content/information from a central, distributed or other local database sources to the mobile device.

A dynamic cache could also consider the following:
If the frequency at which a user connects to a central or distributed task oriented password database is known, then this information may be used to more optimally identify what content needs to be put on the users local mobile device.
If the costs for a user to connect to the central, distributed or other local sources or a range of costs is known, then what content needs to be put on the user's local mobile device may be more optimally identified.
Another metric is the amount of content associated with tasks that need to be completed by the user may include interactive, video clips, media, text and images. By taking into account the amount of task content that needs to be available locally to a user when the task content comes from central, distributed or other local sources may significantly improve optimal downloading of task content.
Furthermore, the amount of task content that needs to be available locally may depend on the users' performance, ability and usage characteristics and may depend on the topic categories and subcategories that need to be available locally to a user when the task content comes from central, distributed or other local sources.
In yet other embodiments, the dynamic cache algorithm takes into account the types of task content such as interactive, video clips, etc. that needs to be available locally to a user when the task content comes from central, distributed or other local sources. By taking into account communication bandwidth typically available to a user when the task content comes from central, distributed or other local sources would also optimize task content/information delivery.

According to a first embodiment, after the tactile pattern is entered, the user is presented a task oriented password screen. This task oriented password screen may require the user to complete one or more tasks before allowing access to the plurality of home screens described above. The number of tasks to be completed may be configured by the task content administrator. For example, in one embodiment, an educational task may be presented to the user. For example, the user may be asked to select the definition of a vocabulary word from a plurality of choices, solve a math problem, identify the capital of a U.S state, or any other educational task. Upon selection or entering of the correct response, the user is then allowed access to the device home screen. In some embodiments, the tasks may be questions presented in a format similar to that found on standardized exams, such as SAT, ACT, GRE, GMAT, LSAT, Advanced Placement, etc. In certain embodiments, more than one correct answer may be required before access to the device home screen is permitted. In certain embodiments, access to the device home screen is permitted only after a plurality of responses have been selected or entered, and/or a predetermined amount of time has elapsed. In some embodiments, a time limit is imposed such that the user must answer within that predetermined duration. In other embodiments, the educational task consumes a fixed amount of time, regardless of how quickly the user responds.

This task oriented password screen is distinguished from the conventional password screen described above. First, a traditional password screen typically requires the user to enter something previously memorized by the user, such as a number or a key sequence. Second, this traditional password is typically static, in that the information entered by the user is not in response to the content or information displayed by the mobile device. Third, this traditional password may be unchanging, requiring the user to enter the same information each time, while the task oriented password screen changes the tasks to complete for each access. In some embodiments, a traditional password screen may require a different input each time, such as when used in conjunction with a FOB. However, in these cases, the user is simply entering a prescribed value. There is no interaction between the content on the password screen and the information being input. Additionally, the task content presented in the task oriented password screen may be user-specific, being selected based on the user's age, educational level, interests, etc. This is not true of traditional password screens.

It should be noted that while this task oriented password activity may only take a few seconds, because of the number of times the typical mobile device is accessed each day, the user may be presented with tens or even hundreds of different questions or tasks during the course of a day. In addition, as mentioned above, multiple questions or tasks may be required to be completed before access to the desired device content is granted.

Thus, in accordance with a first embodiment, the user is presented with a task that needs to be completed and may require selection of the proper response in order to proceed. Although this work that needs to be completed may be from an educational task, as described above, this embodiment is not limited to that. Other types of questions and responses may also be employed.

According to a second embodiment, the user is not required to supply a response, but instead must indicate continued attention to the content being presented or displayed on the display or touchscreen. For example, the task oriented password screen may include an audio or video clip that may be educational in nature. In order to insure that the user watches and is attentive to the entire clip, the application may ask the user to press a certain region of the touchscreen during the clip. If the user does not comply, the clip restarts. This clip may be an arbitrary length, such as up to 15 seconds, although other durations are also possible. Thus, in accordance with a second embodiment, the task oriented password task may include an audio or video clip that requires attention and compliance from the user. In another case, the camera disposed on the device may be used to monitor the user and determine whether the user is being attentive. For example, the camera may be able to distinguish between a full frontal image of the user's face (i.e. attentive), and a side image or lack of a facial image, which may be indicative that the user has looked away. Other methods of judging attentiveness can be employed including the use of sensors in, around, near the device or remote but in communications with the device. Sensor data analysis can significantly help characterize attentiveness and conditions related to user performance. A sensor reading could then influence the task oriented password system in such a way so as to issue a message to an administrator, user or make a communications with a third party as well as alter tasks that need to be completed by the user to gain access to the device contents.

According to a third embodiment, the task oriented password screen comprises the video or audio clip task as described above, but no compliance is required. The clip simply plays to completion, and then the user has completed the task and is then presented the home screen. Thus, in this embodiment, the user has completed a task but is not required to perform any function, but must wait a predetermined amount of time for the designated clip to complete.

In each of these embodiments, as described above, the task content used for the task oriented password screen may be selectable. For example, in some embodiments, the mobile device may be purchased with content that is pre-installed on the device. In other embodiments, the user (or the user's task content administrator) may download the task content from a third party supplier, which supplies task content for this purpose. For example, educational material suppliers, such as textbook publishers, standardized test publishers, or other parties may develop task content specifically designed to be used with this task oriented password screen. The source of this task content may be web-based or contained in a remote database. In some embodiments, the mobile device accesses the remote data and displays it on the touchscreen. In other embodiments, the task content is downloaded to the mobile device and accessed locally.

The task content can be displayed in a variety of ways. In one embodiment, the task content is formatted to fit the screen of the user's device. In another embodiment, the task content may be formatted to fill less than the entirety of the screen area. The remainder space can be used for other purposes. In one embodiment, a portion of the unused screen area is used to display an Encouragement Statement, as described above. In another embodiment, other information may be presented in this unused screen area.

In addition, in some embodiments, the unused region may be along the perimeter of the viewable screen area. In this embodiment, a border may be added to this unused region. In one particular embodiment, an icon is disposed in this unused portion and moves around the perimeter as the task content is being shown. In some embodiments, the user may be required to touch the icon during the presentation of the task content to show that they are actually viewing the screen.

In one embodiment, when the task oriented password screen first appears, it shows an Encouragement Picture, as described above. This image may fade or dissolve as the task content is displayed on the screen for the user. In some embodiments, the Encouragement Picture may appear along the perimeter of the screen area.

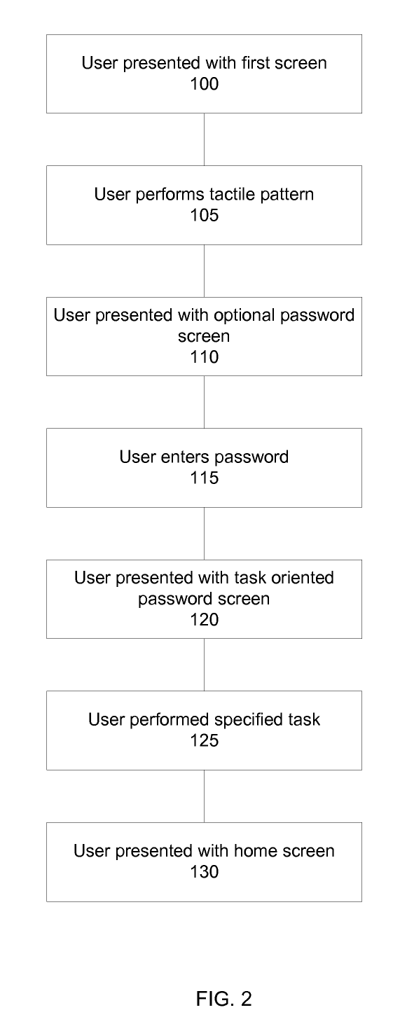

FIG. 2 shows a first sequence that the user may experience when using the present task oriented password software product. As described above, the user is presented with a first screen, which requires a tactile pattern to unlock the mobile device, as shown in step 100. Once the user has performed this tactile pattern, shown in step 105, the mobile device may optionally display a conventional password screen, as shown in step 110. Once the user enters the numeric password or performs the key sequence, as shown in step 115, the mobile device then displays the task oriented password screen as shown in step 120. The user then performs a task or tasks, such as watching or listening to a video or audio clip, solving one or more problems, or answering one or more questions, as shown in step 125. Once this is completed, the mobile device displays the home screen of the mobile device, as shown in step 130. Of course, the mobile device may display a different screen in step 130. It should be noted that the conventional password screen, shown in step 110 is optional and may not be included in the sequence. Furthermore, in those embodiments that include a password screen, the task oriented password screen may be presented to the user either after that password screen (as shown in FIG. 2), or before the password screen, such as immediately after step 105.

Once the user reaches step 130, the operation of the mobile device is unchanged from their previous experiences. Thus, in this embodiment, the task oriented password screen is visible only when the mobile device is first accessed. Thereafter, the user has full and unfettered access to all of their applications and information.

In yet another embodiment, the task oriented password screen is used to block access to only certain device applications. For example, returning to FIG. 2, once the user has entered the tactile pattern (step 105) and the optional password (step 115), he is presented with the task oriented password screen. However, that screen may also include icons representing device applications that the user may access immediately. For example, it may be desirable for the user to be able to utilize the communication feature of the mobile device (such as a telephone) without having to perform the task required by the task oriented password screen first. Additionally, other device applications may also be made available to the user directly from the task oriented password screen, thereby allowing the user to access certain device applications without performing the task, shown in step 125. Thus, in one embodiment, there may be preferential device applications, which are available directly from the task oriented password screen. A preferential device application is one that may be accessed by the user without performing the task specified in step 125. Stated differently, according to one embodiment, the task oriented password screen may include one or more icons for these preferential device applications, allowing the user immediate access to these device applications. These icons may each correspond to a particular device application, although in another embodiment, accessing by tapping the icon for example may allow access to more than one preferential device application. These preferential device applications may include the telephone feature, the clock, the calendar, reminders, notes and others.

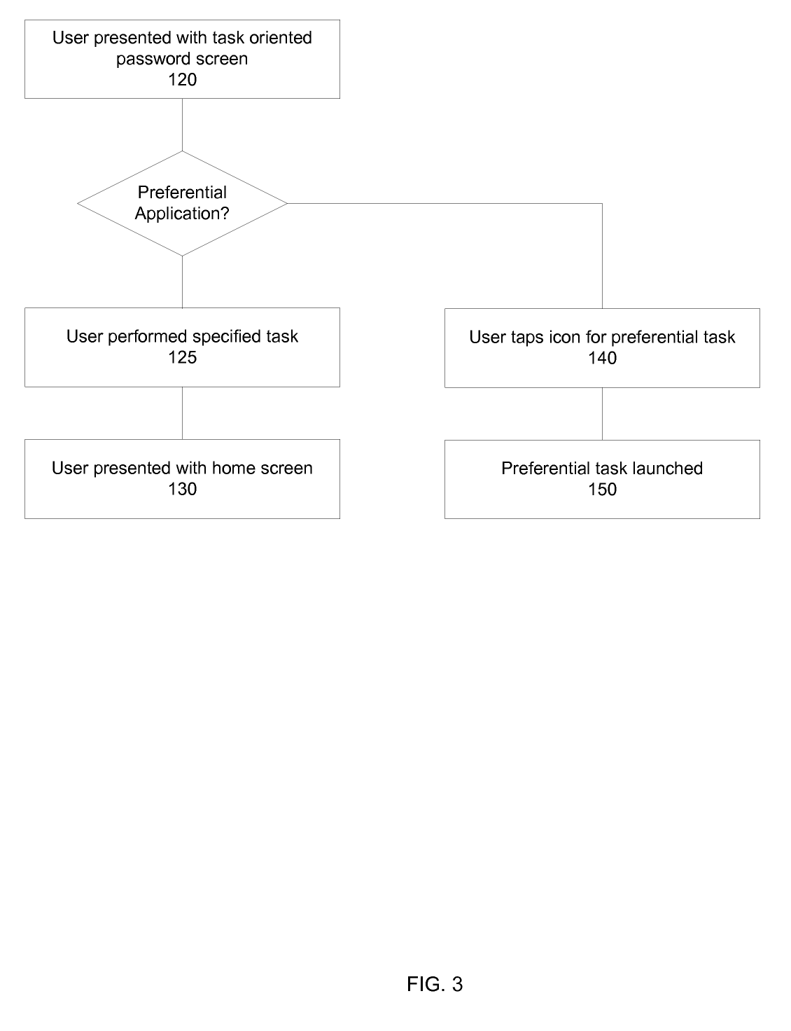

FIG. 3 shows a modified flowchart, which includes these preferential device applications. This flowchart begins at step 120 of FIG. 2, with the prior steps being identical for both embodiments. However, if the application that the user wishes to launch is a preferential device application, the user is able to immediately access that device application, such as by tapping an icon on the task oriented password screen, as shown in step 140. In another embodiment, all preferential device applications may be grouped into a single folder icon, such that the tapping of that icon opens a folder that contains all of the preferential device applications. Once the user taps the icon corresponding to the desired preferential device application, that device application is launched, as shown in step 150. After the user closes the preferential device application, he is returned to the task oriented password screen (step 120). Thus, until the user completes the task (step 125), the task oriented password screen will be displayed to the user. If the application that the user wishes is not a preferential device application, the user may tap on the remainder on the touchscreen, which begins the task oriented password task.

FIGS. 2 and 3 described embodiments where the task oriented password software product is used to restrict access to all or some of the applications on the mobile device, until a specified task is completed by the user. Once the task is completed, the user has unrestricted use of the mobile device. Thus, this may be referred to as device content control at the device level.

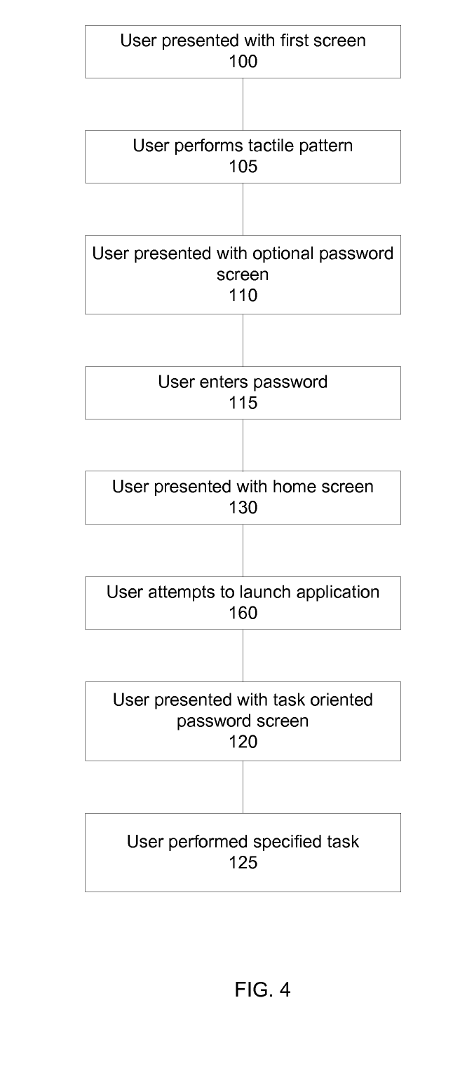

In another embodiment, the task oriented password screen appears after the user attempts to gain access or launch a particular device application. In this embodiment, shown in FIG. 4, the user accesses the mobile device in much the same way as is customary, such as by executing steps 100-115. After this, the user is presented with the home screen, as described earlier and shown in step 130. The user then attempts to gain access or launch a device application, as shown in step 160. However, upon selection of a device application, such as texting or social media, the task oriented password screen appears, as shown in step 120. At this time, the user must complete the task or tasks as described above to gain access or allow the desired device application to launch, as shown in step 125. Stated differently, the task oriented password software component is activated when the user attempts to access the device content in this case a certain device application. As was described earlier, preferential device applications may be established, such that the task oriented password software component does not interfere with the operation or execution of these applications.

In some embodiments, after the user completes the use of the first device application and desires to gain access to a second device application, the task oriented password screen (step 160) appears again. Thus, in this embodiment, the task oriented password screen appears each time the user attempts to gain access to the device content via launching a non-preferential device application.

Thus, in the embodiment of FIG. 4, the task oriented password is used each time the user attempts to gain access to the device content via launching an application. Thus, this version blocks device content access at the application level, while the embodiments of FIGS. 2 and 3 block access at the device level.

Having described the operation of the task oriented password software component, its setup and configuration will be discussed. The task oriented software component may be downloaded onto the mobile device, such as via traditional means, such as the APPLE AppStore and GOGGLE PLAY. In other embodiments, the task oriented password software component may be pre-loaded on the mobile device.

Upon installation, the task oriented password software component may require an access password. This access password may be used to block access to the configuration, installation or deinstallation of the task oriented password software component. In other words, in some embodiments, once the task oriented password software component is installed and configured, it cannot be modified or removed unless the access password is typed. This prevents the deinstallation or modification of the task oriented password software component by the user such as a child or adolescent user.

This configuration may be performed on the user's device or on another computing device. For example, the task content administrator may download the application onto the user's device, and access the configuration module directly from that device. In another embodiment, the application may be downloaded to the user's device, but configuration may be performed remotely. For example, assume that the user's device is a mobile phone. The content administrator may utilize a webpage that enables the content administrator to configure the application on the user's device, which may be uniquely identified by its telephone number or other unique identifier.

The configuration of the task oriented password software component may include multiple steps. For example, the task oriented password software component may include a list of setup configuration options that may be used. The configuration module may inquire as to the age of the user so as to present age-appropriate task content to the user on each task oriented password screen. The configuration module may inquire as to the school grade and/or the sex of the user so as to present appropriate content to the user. In addition, the configuration module may allow the task content administrator to select third party task content to be used during each task oriented password screen.

In addition, other configuration settings may be available. For example, the task oriented password software component may have one or more of the following options:
video only—this option allows the component to be configured such that there is no audio in the task oriented password screens, thereby minimizing inconvenience to others.
Subject matter mix—this option allows the task content administrator to setup or select the desired subject matter, such as math, grammar, spelling, vocabulary, geography, history or other subjects in one or more Knowledge Banks. This option also allows the percentage of each type of subject matter to be set or selected within each Knowledge Bank. Examples of this are shown in FIGS. 6a and 6b.
repeat until answered correctly—this option repeats the same task until the user correctly identifies the answer.
explain wrong answers—this option presents a detailed discussion of why the selected answer was incorrect and/or presents the correct answer and why it was correct.
duration of time for task oriented password screen—this option determines the duration of the task oriented password screen.
preferential device applications—this option allows certain applications to be used without passing through the task oriented password screen.
display at device unlock—this option displays the task oriented password screen at device unlock (see FIG. 2)
display at application launch—this option displays the task oriented password screen when a device application is launched (see FIG. 4)
recycle task frequency—this option determines how frequently tasks are repeated to the user which may include some schedule that suggests repeats occur within some window of time.
difficulty level—this option sets the difficulty of the tasks presented to the user
a hint option—this option allows the user to access one or more hints to the correct response
a list of other administrators (with a login and password) that are allowed to manage various setup configuration options along with which options they can access
others

In some embodiments, as explained above, the software product may also track the achievement or success of the user. For example in one embodiment, the software product can track the number of tasks presented, and the number of correct answers. A score can be generated based on the number of total questions, the number of correct answers and the number of incorrect answers.

The task oriented password system may support a point incentive system that allocates points to the user for completion of work. If the user does extra work, such as by using the “MORE” feature, then extra points may be allocated as an incentive to do more work. The “MORE” feature is a feature that allows the user to get more information related to the task or subcategory viewed by the user. The goal of this incentive system is to both measure usage in a way as to motive the user and encourage them to engage as often and/or as much as possible. The point incentive system may be customizable and geared for motivation and gaming. The point incentive system ties into the Award Sub-System in order to further motive and give encouragement to the user. Note also that the point incentive sub-system adapts to a users' increased skill level or additional work/time spent at their own discretion.

An award sub-system may be designed to allow the administrator to set up a group of awards that will automatically be given to the user upon reaching certain point levels from the point incentive sub-system. Furthermore, the administrator can arrange for a variety of award types including such things as certificates, financial incentives (money cards), special games, eligibility to special competitions, etc.

In some embodiments, the task oriented password system also supports a leader-board that allows competition between users based upon various groupings established by an administrator or user. Allowing the user to setup a leader-board supports socialization where peers compete. This leader-board ranks and displays points earned by a user in comparison to others in one or more groups. Groups could be by age, geography, skill level, etc.

In some embodiments, the task oriented password system also supports a socialization and sharing subsystem designed to allow users to share knowledge, points, awards, etc with others. The sharing can be done by various messaging methods such as emails, twitter, facebook, or other social media methods. This subsystem also allows for development of groups for gaming, research projects, etc. In these cases, the users may earn extra points via the point incentive system and increase their awards. Also, some content administrators can create a research project topic, for which users establish peer or local groups that either compete or do independent research on the topic. This may facilitate earning points identified by the administrator along with their associated awards as determined by the administrator.

In one embodiment, the educational task may be a series of questions, where the user must receive a certain minimum score before access to the desired page is permitted. In a further embodiment, if the user's score is below a predetermined value, the user may be required to access a tutorial on the subject, such as a teaching video clip, flash cards, etc.

In another embodiment, the results of these educational tasks, such as the scores described above, are forwarded, such as via SMS messaging, to another person, such as the task content administrator, parent or teacher of the user. This would give the task content administrator the option to require fewer or more questions before access to the device content is granted, depending on test score. This could also be used to adjust the difficulty of the tasks being presented to the user. For example, if the user consistently gets high scores, the content administrator may increase the grade level of the task content to be more challenging to the user. Conversely, the task content administrator may lower the grade level of the task content if the current task content is too difficult for the user. In another embodiment, the task content administrator, parent or other approved adults may access a webpage, associated with the task oriented password software application, which provides this status remotely. In this way, the adult need not access the user's device in order to be aware of the user's progress and usage statistics.

Additional types of task content are also possible. For example, in one embodiment, a format is made available, such that task content can be created by any third party and delivered as remote task content, as described in conjunction with FIG. 5. For example, a third party may create a webpage or some other formatted task content, accessible to the mobile device or the central or distributed control system and/or its Knowledge Banks, in a specific format that allows the present application to decipher the information and form one or more task oriented password tasks. For example, a teacher may create a webpage or other formatted task content consisting of a number of vocabulary words that will appear on the next test. The present software application may access this webpage or other formatted task content typically from the Knowledge Bank and present one or more of these vocabulary words to the user (with or without the definitions), so that the student can study the words. This can also be used for other educational purposes, such as geography, spelling, math, and other subjects.

In yet another embodiment, the task content may be selected from another source, such as a government or weather alert service. In fact, the task content may be sourced from a broad range of providers, covering a wide variety or subject matter. In such an embodiment, this task content may be sourced, identified and managed by the software system using the Knowledge Bank Categories and Subcategories.

In another embodiment, the task oriented password screen may comprise advertising media. For example, after performing the tactile pattern or biometrics step, a commercial advertisement, which may be of any duration, is displayed. This commercial advertisement may be the only content displayed on the screen or may be displayed in conjunction with any of the other types of task content described herein. This could be in conjunction with a Knowledge Bank and managed therein.

In this case, the user may download the task oriented password component and the task content administrator may cause specific task content to be downloaded in exchange for some perceived benefit, such as discounted rates. For example, if the service provider was paid by a commercial advertiser each time the task oriented password component or task was used, the service provider may be motivated to offer an incentive to users to utilize this software. Thus, the service provider may offer additional minutes, messages, or download capability to a user that downloads and uses the task oriented system. In one specific embodiment, the user is rewarded each time a task oriented password screen is displayed, thereby encouraging use of the system.

In yet another embodiment, the task oriented password display may include a task message or communication that must be responded to. For example, in one embodiment, the mobile device may be configured such that text messages from the parents or administrators of the user are considered tasks (see step 1411 in FIG. 14). In this case, when one of the parent or administrators sends a text message, the text message will be displayed to the user after the tactile pattern is performed (step 120 in FIG. 2). In this way, the user is guaranteed to see this communication. In some embodiments, this task oriented password screen and associated tasks are displayed for a fixed amount of time before allowing the user to access the device. In other embodiments, the user must complete the task by reply to the communication before being granted access to the device. While text is presented as a representative communication, others are possible, such as email, photo, and others.

While the above description suggests an exclusive relationship between a user and a device, the disclosure is not limited to this embodiment. For example, in some embodiments, a single device, such as a tablet, may be shared between multiple children in a household. In this embodiment, the configuration module described above may be used to set up multiple profiles, such as one per child or user. For example, one child may be younger than another child, and therefore, the difficulty of the questions may be tailored to each user's ability. The configuration module may allow the input of a plurality of profiles, each uniquely identified.

In another embodiment, a user can have multiple devices each of which could have the task oriented password software. Each device could work independently as a separate software installation or each device works together to deliver task oriented password tasks managed by the task selection algorithm, users Knowledge Base and setup options.

In this embodiment, after the user performs the tactile pattern to pass the first screen and optionally enters a password (see steps 100-115 of FIG. 2), the user may then be presented with the prelude to the task oriented password screen. This prelude screen may ask the user to identify themselves (such as by name, password, biometric identifier or using some other indicia). Based on this identification, the application will select task content based on the configuration stored in the profile for this user. The application then continues with step 120 (see FIG. 2 or 3).

In some embodiments, the above device specific software component is resident on the mobile device and uses content from one or more task content sources. For example, the software component may be downloaded onto the device. The software component may then allow the task content administrator to select task content from a plurality of task content providers that have agreed to provide task content to the software component. As described above, the task content providers may request a royalty based on the amount of task content consumed or may have another business relationship with the software component, its creator, the task content administrator and/or the user.

In another embodiment, the device specific software component described herein is part of a system where multiple entities are allowed access to the software component. For example, rather than delivering their task content through a generic software component, the task content provider may also provide the device specific software component.

Thus, a system for burst learning is disclosed. The system includes one or more task content providers, a mobile device and a device specific software component disposed in a storage element of the mobile device, wherein the device specific software component presents task oriented passwords to a user, wherein the task oriented passwords comprise task contents received from the task content provider.

Rather than having the user download a plurality of device specific software components for each task content provider, the device specific software component described herein may be designed so as to accommodate all of these task content providers. For example, a first task content provider may include the device specific software component as a part of their offering to the user. Once installed, the user is able to access task content from this particular task content provider. Assume at a later date, the user choose to obtain task content from a second task content provider. Like the first task content provider, the second task content provider includes a device specific software component as part of their offering. However, since both task content providers use the same device specific software component, there is no need to download a second copy of the device specific software component. Rather both task content providers simply make use of a single device specific software component. This architecture is referred to multi-tenant.

In order for this device specific software component to support multiple tenants, several enhancements may be required. For example, the code written to perform the device specific functions must be re-entrant, thereby not allowing multiple instantiations of the code to be running simultaneously but instead having one instantiation of the code running while separating each from the other. Additionally, the task content and knowledge associated with each task content provider must be adequately partitioned, so that task content providers cannot access or modify task content belong to another task content provider.

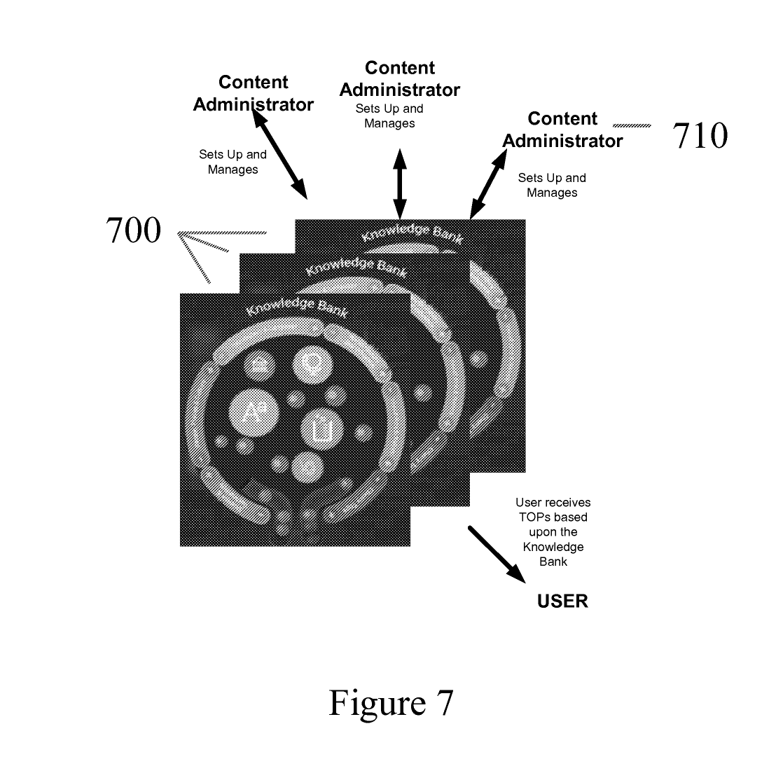

As described above, each task content provider may create a Knowledge Bank into its setup. In some embodiments, a tenant can have multiple Knowledge Banks 700 each having one or more task content administrators 710 as represented in FIG. 7. The software component may also utilize a highly flexible configuration procedure, thereby allowing each task content provider to customize the user experience as desired.

In addition to the requirement of re-entrant code, a multi-tenant architecture imposes other limitations. For example, task content providers that use the device specific software component do not have the ability to modify/upgrade that component, as these modifications must be compatible with all of task content providers that use the software component.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A mobile device, comprising
a processing unit,
a storage element in communication with the processing unit,
a touchscreen,
wherein the storage element comprises instructions,
which when executed by the processing unit:
present a user with a first screen on the touchscreen; and
present the user with a task oriented password screen on the touchscreen, following completion of an action with respect to the first screen, wherein the task oriented password screen requires the user to complete a task in accordance with content displayed on the touchscreen prior to being granted access to one or more applications loaded on the mobile device.

2. The mobile device of claim 1, wherein the content comprises tasks having an educational content.

3. The mobile device of claim 1, wherein the task oriented password screen comprises an icon for a preferential device application that may be accessed without completion of the task.

4. The mobile device of claim 3, wherein the preferential device application comprises a telephony device application.

5. The mobile device of claim 1, wherein the content is in the form of a task that comprises answering a question presented on the task oriented password screen.

6. The mobile device of claim 1, wherein the content is in the form of a task that comprises completing the viewing of a video presented on the task oriented password screen.

7. The mobile device of claim 1, wherein the content is in the form of a task that comprises completing the listening to an audio clip.

8. The mobile device of claim 1, wherein the content is in the form of a task that comprises completing the response to a communication sent to the mobile device by another user.

9. The mobile device of claim 8, wherein the communication is a text message.

10. The mobile device of claim 8, wherein the communication is an email message.

11. The mobile device of claim 1, wherein content of the task comprises advertising media.

12. The mobile device of claim 1, wherein the user completes one or more tasks and the tasks are stored and managed in a one or more local, central and/or distributed database.

13. The mobile device of claim 12, wherein the task content is arranged in the database by topic category and subcategory.

14. The mobile device of claim 13, wherein a task content administrator selects desired frequencies of task content to be delivered by category and subcategory.

15. The mobile device of claim 14, wherein the desired frequencies is modified either manually by the task content administrator or dynamically by a software component depending on users' performance.

16. The mobile device of claim 12, wherein the task content to be delivered to the user is managed by a task selection algorithm.

17. The mobile device of claim 16, wherein the task selection algorithm utilizes parameters set up by a task content administrator and takes into account skill levels, age or skill appropriate content, users' performance, frequencies of category and subcategory material desired, previous task content delivered, attentiveness and sensor readings and order of task content among other items.

18. The mobile device of claim 16, wherein the task selection algorithm may reside within the mobile device, in a central location or a combination thereof.

19. The mobile device of claim 16, wherein the task selection algorithm is designed to provide a multi-tiered knowledge delivery of knowledge in different amount of burst length.

20. The mobile device of claim 19, wherein the multi-tiered knowledge delivery comprises short, medium and long knowledge bursts and a ‘More’ feature and an independent research option or educational games.

21. The mobile device of claim 16, wherein the task selection algorithm to select which task oriented password task to deliver next is implemented and guided by a multilayered state transition matrix, a Markov model or other method to allow the next task to be identified with easy setup and modification by one of more administrators.

22. The mobile device of claim 16, wherein the task selection algorithm to select which task oriented password task to deliver next is implemented and guided by a multilayered state transition matrix, a Markov model or other method to allow for automatic adjustment based upon user performance and other setup parameters.

23. The mobile device of claim 16, wherein the task selection algorithm to select which task oriented password task to deliver next exists for each Knowledge Bank.

24. A task oriented password system for burst learning, comprising one or more task content providers, a mobile device and a device specific software component disposed in a storage element of the mobile device, wherein the device specific software component presents task oriented passwords to a user, wherein the task oriented passwords comprise task content received from the task content provider.

25. The system of claim 24, wherein the task oriented password system is designed to support multiple tenants.

26. The system of claim 25, wherein the task oriented password system is designed to easily and rapidly add or remove tenants.

27. The system of claim 24, wherein the task oriented password system is designed to easily and rapidly add geographies and languages.

28. The system of claim 24, wherein the task oriented password system is designed to support a point incentive system.

29. The system of claim 28, wherein the point incentive system is customizable and geared for motivation and gaming.

30. The system of claim 28, wherein the point incentive system adapts based upon a users increased skill level or additional time/work that the user completes at their own discretion.

31. The system of claim 28, wherein the task oriented password system supports an award system.

32. The system of claim 31, wherein the award system is different for each tenant, is setup and controlled by an administrator and supports a variety of awards.

33. The system of claim 31, wherein the award system ties into the point incentive system.

34. The system of claim 33, wherein the award system automatically issues awards based upon the point incentive system.

35. The system of claim 24, wherein the task oriented password system supports a Leader-Board that ranks and displays points earned by a user in comparison to others.

36. The system of claim 24, wherein the task oriented password system supports a socialization and sharing system.

37. The system of claim 36, wherein the socialization and sharing system allows users to share knowledge, points, and awards.

38. The system of claim 36, wherein the socialization and sharing system allows sharing by messaging, emails or other social media methods.

39. The system of claim 36, wherein the socialization and sharing system allows for development of groups for gaming, and research projects.

40. The system of claim 24, wherein the task oriented password system restricts access to the mobile device by taking control of the mobile device to force work to be completed in order to gain further access to device content on the mobile device after the mobile device awakens or is powered up in some manner.

41. The system of claim 24, wherein the task oriented password system restricts access and takes control by creating special device functions that launch task oriented passwords upon awaking or being powered on.

42. The system of claim 24, wherein the task oriented password system takes control by using existing or other available device functions such as parental control features or other related methods.

43. The system of claim 40, wherein after the task oriented password system restricts access and takes control it may also offer special features such as an emergency access feature that allows access to selected device applications such as a communications application or features that allow access and interaction with a limited set of device applications.

44. The system of claim 40, wherein after the task oriented password system restricts access and takes control it may also offer special features such as a kill feature that might be used to “unfreeze” an apparently “frozen” device.

45. The system of claim 40, wherein after the task oriented password system takes control, the mobile device displays a message from an administrator in place of or in conjunction with a task oriented password.

46. The system of claim 24, wherein the task oriented password system dynamically adjusts the size and format of a task oriented password task to match the visual, audio or sensor features of the mobile device.

47. The system of claim 24, wherein the task oriented password system allows a task content administrator to break a potential task oriented password into multiple sequentially or randomly ordered task oriented passwords.

48. The system of claim 24, wherein the task oriented password system has a reporting subsystem.

49. The system of claim 48, wherein the reporting subsystem monitors and reports client user usage statistics to content administrators.

50. The system of claim 48, wherein the reporting subsystem monitors and reports task oriented password images, videos, audios, text and other task content usage statistics to task content providers.

51. The system of claim 48, wherein the reporting subsystem monitors and reports content administrator and other administrator usage.

52. The system of claim 24, wherein the task oriented password system works in conjunction with various sensor systems.

53. The system of claim 52, wherein the various sensor systems are included in/around or in proximity to the mobile device.

54. The system of claim 52, wherein the various sensor systems are remote and in communication with the mobile device.

55. The system of claim 52, wherein the task oriented password system is influenced by sensor readings in such a way so as to alter the task oriented password selected.

56. The system of claim 52, wherein the task oriented password system is influenced by sensor readings in such a way so as to issue a message to an administrator or make a communications with a 3^{rd} party.

57. The system of claim 52, wherein the task oriented password system is influenced by sensor readings in such a way so as to issue a message or an alert to the user.

58. The system of claim 24, wherein the task oriented password system is designed to support a dynamic cache algorithm acting as a feedback control system to move task content from a central, distributed or other local database sources to the mobile device.

59. The system of claim 58, wherein the dynamic cache algorithm takes into account how often a user connects to the central, distributed or other local sources.

60. The system of claim 58, wherein the dynamic cache algorithm takes into account the costs for a user to connect to the central, distributed or other local sources.

61. The system of claim 58, wherein the dynamic cache algorithm takes into account the amount of task content that needs to be available locally to a user when the task content comes from central, distributed or other local sources.

62. The system of claim 61, wherein the amount of task content that needs to be available locally may depend on the users' performance, ability and usage characteristics.

63. The system of claim 58, wherein the dynamic cache algorithm takes into account the topic categories and subcategories that needs to be available locally to a user when the task content comes from central, distributed or other local sources.

64. The system of claim 58, wherein the dynamic cache algorithm takes into account the types of task content that needs to be available locally to a user when the task content comes from central, distributed or other local sources.

65. The system of claim 58, wherein the dynamic cache algorithm takes into account communication bandwidth typically available to a user when the task content comes from central, distributed or other local sources.
